(19) United States
(12) Patent Application Publication
(10) Pub. No.: US 2024/0034090 A1
(43) Pub. Date: Feb. 1, 2024

(54) ERASER CASE

(71) Applicant: PLUS CORPORATION, Tokyo (JP)

(72) Inventor: Togo MATSUSHITA, Tokyo (JP)

(21) Appl. No.: 18/483,876

(22) Filed: Oct. 10, 2023

Related U.S. Application Data
(63) Continuation of application No. PCT/JP2021/043128, filed on Nov. 25, 2021.

(51) Int. Cl. B43L 19/00

(52) U.S. Cl. CPC B43L 19/0068

(57) ABSTRACT

An eraser case includes a cylindrical container in which an eraser with a cylindrical hole is stored to be extendable and retractable. A twist-up base is slidable in an axial direction inside the cylindrical container, and an end part of an eraser stored in the cylindrical container is fixed to the twist-up base. A screw shaft body can be inserted into the cylindrical hole of the eraser and can push the twist-up base out by being inserted into and threadedly engaged with a screw hole piercing through the twist-up base to convert an axial rotational motion into an axial motion of the twist-up base. The twist-up base includes a convex locking portion protruding toward the eraser. The convex locking portion fixes the eraser to the twist-up base by being locked to a concave locking portion provided on an inner wall surface of the cylindrical hole of the eraser.

### CROSS REFERENCE TO RELATED APPLICATIONS

This application is a continuation under 35 U.S.C. § 120 of PCT/JP2021/043128, filed Nov. 25, 2021, which is claimed as priority and is incorporated herein by reference.

### BACKGROUND OF THE INVENTION

### 1. Field of the Invention

The present invention relates to a storage tool for an eraser.

### 2. Description of the Related Art

Conventionally, as a container from which a stick-type solid glue can be extended and used, a twist-up container for a solid glue stick is known and used by rotating the tail cap attached to the lower end of the cylinder body to extend the solid glue (see Patent Literature 1, for example).
Patent Literature 1: Japanese Unexamined Patent Application Publication No. 2008-284820

However, in the technology described in Patent Literature 1, it is necessary to screw the end part of the solid glue stick into a spiral rib provided on the inner circumferential surface of the cylindrical slider. Therefore, it is difficult to use the solid glue stick to the end because the end part of the solid glue stick screwed into the slider is covered by the slider and is not exposed. When considering the application of the technology described in Patent Literature 1 to the storage of a solid object such as an eraser, for example, it is assumed that using the eraser to the end would be difficult, similarly to the case of a solid glue stick.

### SUMMARY OF THE INVENTION

The present invention has been made in view of such a situation, and a purpose thereof is to provide an eraser case that facilitates the use of an eraser.

In response to the above issue, an eraser case according to one aspect of the present invention includes: a cylindrical container in which an eraser with a cylindrical hole is stored to be extendable and retractable through an opening at the tip; a twist-up base that is slidable in an axial direction inside the cylindrical container and to which an end part of an eraser stored in the cylindrical container is fixed; and a screw shaft body that can be inserted into the cylindrical hole of the eraser and that can push the twist-up base out by being inserted into and threadedly engaged with a screw hole piercing through the twist-up base to convert an axial rotational motion into an axial motion of the twist-up base. The twist-up base includes a convex locking portion protruding toward the eraser, and the convex locking portion fixes the eraser to the twist-up base by being locked to a concave locking portion provided on an inner wall surface of the cylindrical hole of the eraser.

The convex locking portion of the twist-up base may have a shape of a snap fit joint protruding upward from the upper surface of the base body. The concave locking portion may have a concave shape into which the convex shape of the convex locking portion fits. According to this aspect, with the convex locking portion locked to the concave locking portion, the eraser can be fixed such as to be placed on the upper surface of the base body of the twist-up base. In this case, the end part of the eraser can be exposed without being hidden by the twist-up base, making it easier to use the eraser to near the end and reducing waste.

Each of an inner wall surface of the cylindrical container and an outer circumferential surface of the twist-up base may have an axial cross-sectional shape other than a perfect circle, such as a polygon with multiple vertices, including a hexagon, rectangle, and square, or an ellipse. According to this aspect, when the screw shaft body is rotated, the eraser is prevented from performing an axial rotational motion along with the screw shaft body inside the cylindrical container to interfere with the axial motion of the eraser.

The screw shaft body may include a screw shaft part including, on at least part of its outer circumference, a spiral screw thread that can be threadedly engaged with the screw hole in the twist-up base, and, on the outer circumference of the screw shaft part, an idling section that is not threadedly engaged with the screw hole may be provided in at least one of the vicinity of the tip or the vicinity of the end in an axial direction, and a thread section that can be threadedly engaged with the screw hole may be provided in a portion other than the idling section. The outer circumference of the screw shaft part may include, in an axial direction, a first thread section provided in part of the vicinity of the tip, an idling section that is not threadedly engaged with the screw hole and is provided in the vicinity of the tip other than the first thread section, and a second thread section provided in a portion other than the first thread section and the idling section. An axial length of the idling section may be equal to or greater than an axial length of the screw hole in the twist-up base. According to this aspect, with the idling of the screw shaft part, coming off of the twist-up base from the cylindrical container due to excessive extension and damage to another member in the inner bottom of the cylindrical container due to excessive retraction of the twist-up base can be prevented.

The cylindrical container may have a bottomed shape without a lid. The twist-up base can be in contact with another member in an inner bottom of the cylindrical container when the screw shaft body is rotated in the storing direction, an elastic mechanism may be provided in the portion in contact with another member, and the section of the screw hole in the twist-up base and the idling section can overlap due to deformation of the elastic mechanism. In the twist-up base, an elastic mechanism may be provided such that part thereof protrudes toward an inner wall surface of the cylindrical container and can be in contact with the inner wall surface. According to this aspect, the twist-up base is pressed against the inner wall surface of the cylindrical container due to deformation of the elastic mechanism, causing less play and preventing generation of unnecessary noise. Also, when the screw shaft body in the idling section is rotated, the twist-up base positioned at the inner bottom of the cylindrical container is biased upward by the rebound resilience of the elastic mechanism and moved to the second thread section, thereby releasing the idling.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 illustrates an appearance of an eraser case according to a first embodiment;

FIG. 2 illustrates a configuration of the eraser case and an eraser;

FIG. 3 illustrates a structure of a screw shaft body;

FIG. 4 illustrates a state where the eraser and a twist-up base are extended and moved to the tip of the screw shaft body;

FIG. 5 is a perspective view of the twist-up base viewed obliquely from a lower side;

FIG. 6 is a sectional view of the twist-up base;

FIG. 7 shows a positional relationship when the twist-up base is positioned on the end side of a screw shaft part;

FIG. 8 shows a relationship in terms of shape between a cylindrical container and the eraser viewed from the tip side of the eraser case;

FIG. 9 shows a relationship in terms of shape between the cylindrical container and the twist-up base viewed from the tip side of the eraser case;

FIG. 10 illustrates an appearance of an eraser case according to a second embodiment;

FIG. 11 illustrates an internal configuration of the eraser case without the cylindrical container;

FIG. 12 illustrates a process of attaching the screw shaft body and a stop element to the cylindrical container;

FIG. 13 is a sectional view that shows an internal structure of the eraser case;

FIG. 14 is a sectional view that shows a state of the eraser worn down to the maximum;

FIG. 15 shows a relationship in terms of shape between the cylindrical container and the eraser viewed from the tip side of the eraser case;

FIG. 16 shows a relationship in terms of shape between the cylindrical container and the twist-up base viewed from the tip side of the eraser case;

FIG. 17 shows a relationship in terms of shape between the cylindrical container and the stop element viewed from the tip side of the eraser case; and

FIG. 18 illustrates an appearance of an eraser case according to a third embodiment.

### DETAILED DESCRIPTION OF THE INVENTION

The invention will now be described by reference to the preferred embodiments. This does not intend to limit the scope of the present invention, but to exemplify the invention.

### First Embodiment

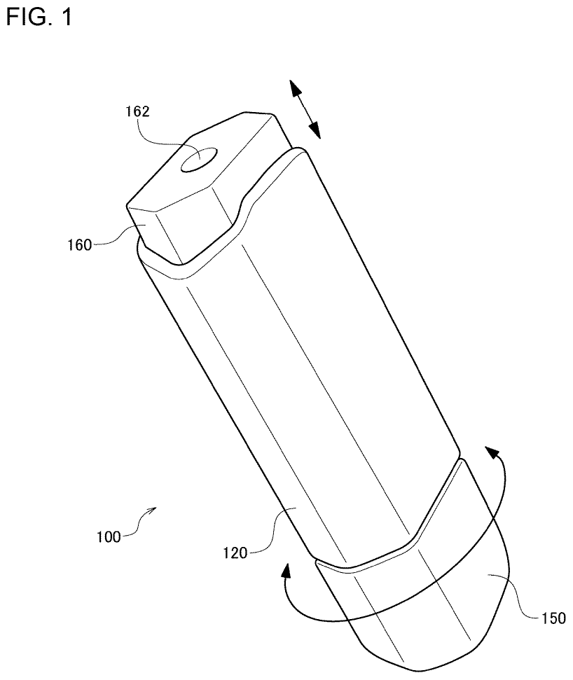

FIG. 1 illustrates an appearance of an eraser case according to the first embodiment. An eraser case 100 mainly includes a cylindrical container 120, a screw shaft body (not illustrated in FIG. 1), and a rotary operating body 150. The cylindrical container 120 is a bottomed cylindrical resin member without a lid and has an axial cross-sectional shape of a rounded flat hexagon with a large radius of curvature. An eraser 160 has a hexagonal prism shape of which an axial cross-sectional shape is a rounded flat hexagon with a small radius of curvature in which a cylindrical hole 162 is formed through the central axis. The outer diameter of the eraser 160 is slightly smaller than the inner diameter of the cylindrical container 120, and the eraser 160 can be stored in the cylindrical container 120 with a slight gap left around the eraser 160. The screw shaft body is a resin member including a screw shaft part, not illustrated in FIG. 1. The screw shaft part is inserted into the cylindrical hole 162 of the eraser 160 stored in the cylindrical container 120 and also into a hole provided in a bottom part of the cylindrical container 120. To the end of the screw shaft body, the rotary operating body 150 is attached. By rotating the rotary operating body 150 in a predetermined direction, such as the clockwise direction, the eraser 160 is extended from the cylindrical container 120 and, by rotating the rotary operating body 150 in the opposite direction, such as the counterclockwise direction, the eraser 160 is retracted into the cylindrical container 120. The cylindrical container 120 includes a concave shape such that a side edge end at the tip is shaved off toward the end side, thereby sufficiently exposing corner portions and their vicinities of the eraser 160 exposed through a tip opening of the cylindrical container 120. This prevents the cylindrical container 120 from interfering with the action of placing a corner of the eraser 160 against paper and erasing letters and the like.

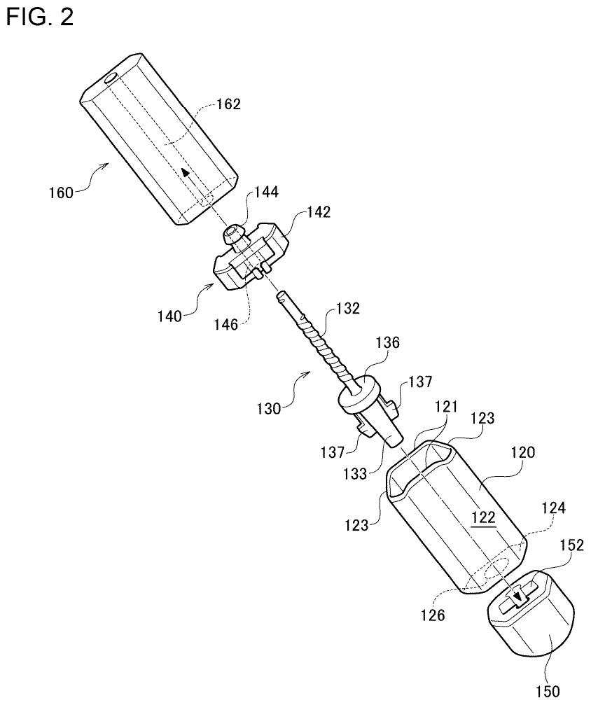

FIG. 2 illustrates a configuration of the eraser case 100 and the eraser 160. The cylindrical hole 162 in the eraser 160 is a cylindrical hole formed through the central axis. The opening on the tip side of the cylindrical hole 162 in the eraser 160 does not have any particular function or role. Accordingly, as a modification, the cylindrical hole 162 may be structured to extend to near the tip of the eraser 160 but not completely pierce through to the tip, i.e., to have an opening only on the end side. However, by configuring the cylindrical hole 162 to pierce through to the tip side, the eraser 160 can be manufactured by extrusion or injection molding with a constant cross-sectional shape from the tip to the end, thereby simplifying the manufacturing process.

A twist-up base 140 is a resin member that includes a base body 142 having a hexagonal prism shape of which at least part of the cross-sectional shape is almost a rounded flat hexagon, and a convex locking portion 144 protruding upward from the center of the upper surface of the base body 142. The convex locking portion 144 has at the tip, a shape of an annular snap fit joint folded back like an umbrella, i.e., a click folded back in a tapered sloping shape is provided around the tip of a projection, and the folded end portion is formed at about 90 degrees. When the convex locking portion 144 is press-fitted into the cylindrical hole 162 of the eraser 160, the folded end portion is locked and fixed to a concave locking portion, which will be detailed later, provided near the end of the cylindrical hole 162. At the center of the base body 142, a cylindrical base hole 146 is formed through the base body 142 and the convex locking portion 144. The base hole 146 is a screw hole with a thread groove spirally formed on its inner wall. The outer diameter of the base body 142 is slightly smaller than the inner diameter of the cylindrical container 120, and the base body 142 is slidable in the axial directions inside the cylindrical container 120.

The cylindrical container 120 includes, at the circumferential edge of the tip opening, concave shapes such that side edge ends 123 corresponding to short sides are shaved off toward the end side, with respect to tip edge parts 121 corresponding to long sides of the six sides of the rounded flat hexagon. The concave shapes of the side edge ends 123 sufficiently expose corner portions and their vicinities of the eraser 160 exposed through the tip opening of the cylindrical container 120. This prevents the side edge ends 123 from interfering with the action of placing a corner of the eraser 160 against paper and erasing letters and the like. Inside the cylindrical container 120, a bottom hole 126 is provided at the center of a bottom part 124.

A screw shaft body 130 includes a screw shaft part 132, which is a rod-shaped member with a spiral screw thread formed on the outer circumference, a pair of protruding pieces 133 and a pair of hook pieces 137 protruding toward the end of the screw shaft body 130, and a discoid part 136 provided at the base of the screw shaft part 132. The shaft diameter of the screw shaft part 132 is smaller than the hole diameter of the cylindrical hole 162 such that, when the screw shaft part 132 is inserted into the cylindrical hole 162 of the eraser 160, the outer circumference of the screw shaft part 132 does not come into contact with the inner wall surface of the cylindrical hole 162. Also, the shaft diameter of the screw shaft part 132 is smaller than the hole diameter of the base hole 146 of the twist-up base 140 such that the screw shaft part 132 is threadedly engaged with the base hole 146.

To the pair of protruding pieces 133 and the pair of hook pieces 137, the rotary operating body 150 is attached. The rotary operating body 150 is attached to the end side of the screw shaft part 132 and functions as a screw head. The pair of hook pieces 137 have a shape of a snap fit joint and are deformed and press-fitted into the bottom hole 126, which is narrower than the maximum width portion of the pair of hook pieces 137 and fitted together with the protruding pieces 133 into a cross-shaped attachment hole 152 of the rotary operating body 150. As with the cylindrical container 120, the rotary operating body 150 is a resin member of which at least part of an axial cross-sectional shape is a rounded flat hexagon with a large radius of curvature.

The discoid part 136 is provided between the screw shaft part 132 and a portion including the protruding pieces 133 and the hook pieces 137 and has a discoid shape of which the outer diameter is wider than the shaft diameters of the screw shaft part 132 and the protruding pieces 133. The upper surface of the discoid part 136 may be in contact with a lower end of the twist-up base 140 retracted in the storing direction. In other words, the discoid part 136 has a function as a stopper to stop the twist-up base 140 retracted in the storing direction at its lowest end position. The outer diameter of the discoid part 136 is larger than the hole diameter of the bottom hole 126 of the cylindrical container 120, so that the discoid part 136 does not pass through the bottom hole 126, and the lower surface of the discoid part 136 comes into contact with the bottom part 124. Thus, the rotary operating body 150 is attached to the screw shaft part 132 such that the discoid part 136 and the rotary operating body 150 sandwich the bottom part 124 of the cylindrical container 120, so that the rotary operating body 150 is configured integrally with the screw shaft body 130. A user holds the circumference of the rotary operating body 150 and rotates it clockwise to extend the eraser 160 or rotates it counterclockwise to retract the eraser 160 into the cylindrical container 120.

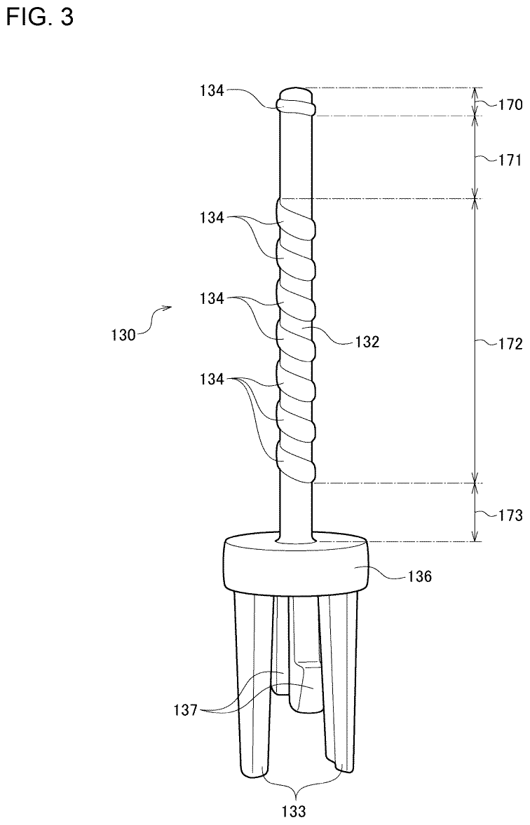

FIG. 3 illustrates a structure of the screw shaft body 130. The screw shaft body 130 has on its end side, the pair of protruding pieces 133 and the pair of hook pieces 137 protruding toward the end. Between the screw shaft part 132 and a portion including the protruding pieces 133 and the hook pieces 137, the discoid part 136 is provided. The pair of protruding pieces 133 are provided respectively at opposite positions around the shaft core of the screw shaft body 130. The pair of hook pieces 137 are also provided respectively at opposite positions around the shaft core of the screw shaft body 130. The protruding pieces 133 and the hook pieces 137 are provided alternately at intervals of 90 degrees such as to be mutually adjacent along a lower surface arc of the discoid part 136.

The screw shaft part 132 is divided into a first thread section 170, a first idling section 171, a second thread section 172, and a second idling section 173. In the first thread section 170 located near the tip of the screw shaft part 132, a screw thread 134 is formed for a short section of about one revolution on the outer circumference of the screw shaft part 132. In the first idling section 171 adjacent to the end side of the first thread section 170, no screw thread is provided for a section corresponding to a screw thread for about two revolutions and hence the section is not threadedly engaged with the screw hole. In the second thread section 172 adjacent to the end side of the first idling section 171, a screw thread 134 is formed for about seven revolutions. In the second idling section 173 adjacent to the end side of the second thread section 172, no screw thread is provided for a section corresponding to a screw thread for about two revolutions and hence the section is not threadedly engaged with the screw hole. Accordingly, when the screw shaft part 132 is screwed into the base hole 146 of the twist-up base 140, the twist-up base 140 can be moved up and down when the first thread section 170 or the second thread section 172 is threadedly engaged with the screw groove in the base hole 146. However, when the twist-up base 140 reaches the first idling section 171 or the second idling section 173, the screw shaft part 132 is not threadedly engaged with the base hole 146 and hence idles.

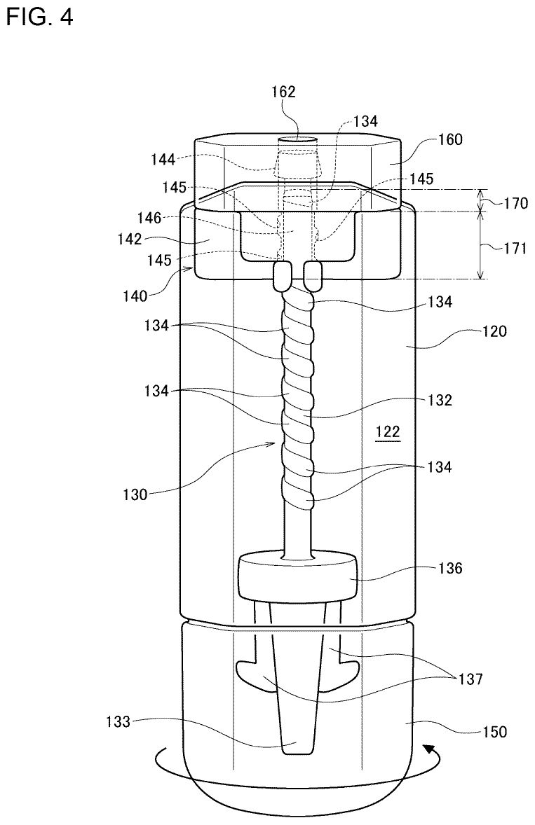

FIG. 4 illustrates a state where the eraser 160 and the twist-up base 140 are extended and moved to the tip of the screw shaft body 130. For the sake of convenience, FIG. 4 shows an example in which the eraser 160, the twist-up base 140, and the screw shaft body 130 can be visually recognized through the cylindrical container 120 and the rotary operating body 150, such as the case where the cylindrical container 120 and the rotary operating body 150 are formed of a translucent resin member.

When a user rotates the rotary operating body 150 of the screw shaft body 130, the axial rotational motion of the screw shaft body 130 is converted into an axial motion, i.e., a linear motion, of the twist-up base 140 by the threaded engagement of the screw shaft part 132 and the twist-up base 140. For example, when the rotary operating body 150 is rotated counterclockwise, the eraser 160 and the twist-up base 140 are retracted toward a bottom part of a housing part 122 and stored, and, when the rotary operating body 150 is rotated clockwise, the eraser 160 and the twist-up base 140 are extended and moved in the direction toward the tip opening of the housing part 122. The more the eraser 160 and the twist-up base 140 are extended and moved, the more the tip of the eraser 160 is pushed out and exposed outside the cylindrical container 120. One rotation of the rotary operating body 150 moves the eraser 160 up and down by about 3.0 mm, and the amount of the eraser 160 exposed to the outside can be freely adjusted by the amount of rotation of the rotary operating body 150. When the eraser 160 becomes worn and short as it is used, by rotating the rotary operating body 150 clockwise by the shortened amount, the tip of the eraser 160 can be exposed outside the cylindrical container 120.

The eraser 160 in FIG. 4 has already been worn down by use and its entire length has become short. In order to use the eraser 160 to reach such a state where the entire length of the eraser 160 is short, i.e., up to near the contact point between the eraser 160 and the twist-up base 140, it is necessary to expose the entire eraser 160, including the end portion, to the outside of the cylindrical container 120. In this regard, since the screw shaft part 132 of the screw shaft body 130 is long enough so that the tip thereof reaches the vicinity of the tip opening of the cylindrical container 120, the twist-up base 140 can be moved upward to the vicinity of the tip opening of the cylindrical container 120. Also, since the eraser 160 is fixed such as to be placed on the upper surface of the twist-up base 140 so that the entire eraser 160 is exposed, by moving the twist-up base 140 to the vicinity of the tip opening of the cylindrical container 120, the entire eraser 160, including the vicinity of the end thereof, can be exposed outside the cylindrical container 120. Accordingly, the end of the eraser 160 is not hidden by the cylindrical container 120 or the twist-up base 140, and the eraser 160 can be used up to the very end, enabling the use of the eraser 160 without waste. Meanwhile, it is difficult to use an eraser of which the size has become too precarious to pick up with fingers for use. However, with the eraser case 100 according to the present embodiment, even an eraser with such precarious size can be used, so that, also in this regard, an eraser can be used easily to the end without waste.

When the rotary operating body 150 is rotated clockwise to extend and move the eraser 160 and the twist-up base 140 maximally to the tip of the screw shaft body 130, the twist-up base 140 reaches the first idling section 171 and is placed in the state shown in FIG. 4. As illustrated, when the position of the first idling section 171 and the position of a screw groove 145 in the base hole 146 overlap, the threaded engagement of the screw shaft body 130 and the screw groove 145 is released, and the screw shaft body 130 idles. While the screw shaft body 130 idles, the twist-up base 140 and the eraser 160 will not be extended any further even if the rotary operating body 150 is further rotated clockwise, thereby preventing the coming off of the twist-up base 140 from the cylindrical container 120 due to excessive extension.

The length of the first idling section 171 is equal to or greater than the axial length of an internal threaded section, in which the screw groove 145 is provided on the inner wall surface of the base hole 146. Even if the eraser 160 in the illustrated state is pulled up, the twist-up base 140 will not easily come off because the screw groove 145 of the base hole 146 is caught on the first thread section 170 of the screw shaft body 130. Thus, by providing the first thread section 170 near the tip of the screw shaft part 132 such that the screw thread 134 in the first thread section 170 is caught by the screw groove 145 in the base hole 146, easy coming off of the twist-up base 140 from the screw shaft body 130 can be prevented. In other words, when the eraser 160 is removed from the twist-up base 140 that has been moved toward the tip opening maximally, coming off of the twist-up base 140 together with the eraser 160 from the screw shaft body 130 can be prevented.

After a used eraser 160 is removed from the twist-up base 140, by rotating the rotary operating body 150 clockwise while pinching and pulling the convex locking portion 144, the first thread section 170 starts to be threadedly engaged with the screw groove 145 in the base hole 146, so that the twist-up base 140 can be moved outward again; accordingly, the twist-up base 140 can also be removed from the screw shaft body 130. Also, since the first thread section 170, which is a thread in a short section, is provided near the tip of the screw shaft part 132, in the assembly of the components of the eraser case 100, the twist-up base 140 can be easily inserted into the cylindrical container 120 merely by threadedly engaging the twist-up base 140 with the tip of the screw shaft body 130 and slightly rotating the twist-up base 140.

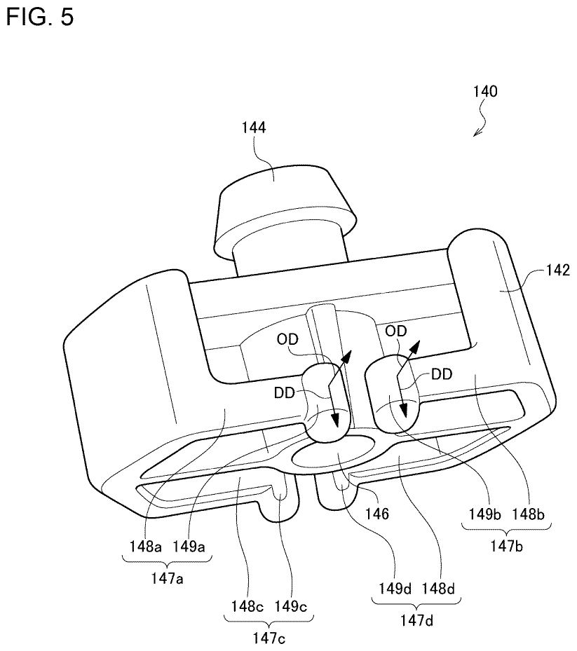

FIG. 5 is a perspective view of the twist-up base 140 viewed obliquely from a lower side. In the twist-up base 140, the convex locking portion 144 is provided on the upper surface of the base body 142, and two pairs of elastic mechanisms 147 are provided on side surfaces of the base body 142. Each elastic mechanism 147 is provided such that part thereof protrudes toward the inner wall surface of the cylindrical container 120 and can be in contact with the inner wall surface. Also, each elastic mechanism 147 is provided in a portion that can be in contact with another member in the inner bottom of the cylindrical container 120 when the screw shaft part 132 is rotated in the storing direction. Each elastic mechanism 147 is constituted by an L-shaped protruding piece 148 that bends at a right angle from the lower end of a line connecting upper and lower corners of the base body 142 and extends to the center of a side portion, and a tip bulge 149 provided at the tip of the L-shaped protruding piece 148.

On one side surface of the base body 142, a first elastic mechanism 147a, which is constituted by a first L-shaped protruding piece 148a and a first tip bulge 149a, and a second elastic mechanism 147b, which is constituted by a second L-shaped protruding piece 148b and a second tip bulge 149b, are provided and constitute a pair of elastic mechanisms. The first L-shaped protruding piece 148a and the second L-shaped protruding piece 148b extend in opposite directions. On the opposite side surface of the base body 142, a third elastic mechanism 147c, which is constituted by a third L-shaped protruding piece 148c and a third tip bulge 149c, and a fourth elastic mechanism 147d, which is constituted by a fourth L-shaped protruding piece 148d and a fourth tip bulge 149d, are provided and constitute the other pair of elastic mechanisms. The third L-shaped protruding piece 148c and the fourth L-shaped protruding piece 148d extend in opposite directions.

Each of the L-shaped protruding pieces 148a-148d is a resin piece having flexibility and rebound resilience; accordingly, each L-shaped protruding piece is bent by pressure deformation in the vertical and lateral directions and can also exert repulsion against the pressure deformation. Each of the tip bulges 149a-149d has a shape that bulges from a side surface of the base body 142 in an outward direction OD and a downward direction DD, such as to extend out of the contour line of the base body 142 in the outward direction OD and the downward direction DD by the amount of the bulge. When the portion of a tip bulge 149 extending out is pressed against another member, the corresponding L-shaped protruding piece 148 bends, causing repulsion.

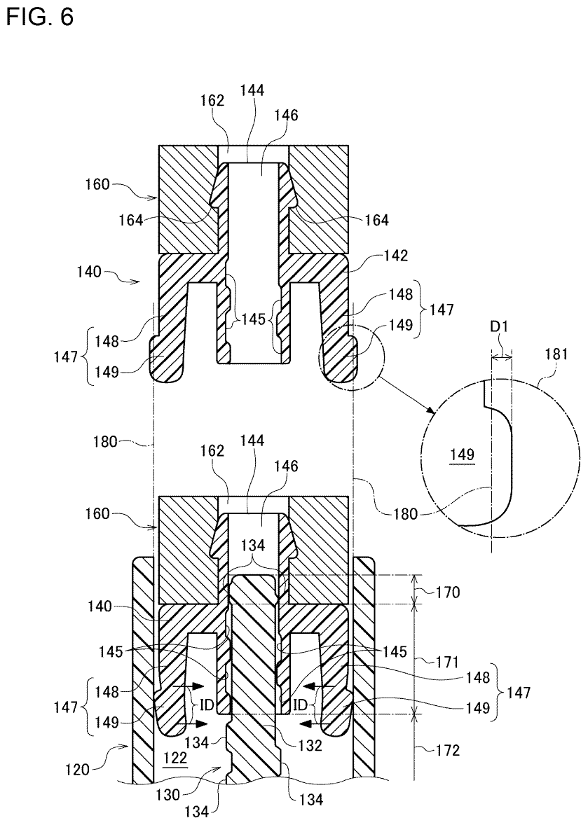

FIG. 6 is a sectional view of the twist-up base 140. The upper part of FIG. 6 illustrates a cross section of the twist-up base 140 with the convex locking portion 144 fitted into the cylindrical hole 162 of the eraser 160. The lower part of FIG. 6 illustrates a cross section with the twist-up base 140 and the eraser 160 attached to the tip of the screw shaft body 130 inside the cylindrical container 120.

As shown in the upper part of FIG. 6, the convex locking portion 144 of the twist-up base 140 has a shape of an annular snap fit joint protruding cylindrically upward from the base body 142. The outer diameter of the convex locking portion 144 at its base or end (near the contact point with the base body 142) is slightly smaller than the hole diameter of the cylindrical hole 162 of the eraser 160. Also, the convex locking portion 144 has an umbrella-like folded shape in which the outer diameter near the center in an axial direction of the convex locking portion 144 extends in a radial direction such as to bulge substantially vertically from the outer diameter at the base or end and tapers conically therefrom toward the tip. The base hole 146, piercing through the center of the base body 142 and the convex locking portion 144, is a screw hole with the screw groove 145 spirally formed on its inner wall, and the hole diameter thereof is slightly larger than the outer diameter of the screw shaft part 132 and is of sufficient size to allow the screw shaft part 132 to be threadedly engaged with the base hole 146.

On the inner wall surface of the cylindrical hole 162 of the eraser 160, near the end, a concave locking portion 164 is formed in a shape that the convex locking portion 144 can fit into. More specifically, the cylindrical hole 162 has a shape in which the end side of the concave locking portion 164 is slightly recessed substantially vertically or in a radial direction such that the hole diameter of the cylindrical hole 162 becomes maximum at the position of the concave locking portion 164 and inclined therefrom such that the hole diameter of the cylindrical hole 162 becomes smaller toward the tip side. The hole diameter of the cylindrical hole 162, excluding a portion corresponding to the convex locking portion 144, is slightly larger than the outer diameter of the base or end of the convex locking portion 144. Also, the largest outer diameter of the convex locking portion 144 is larger than the hole diameter of the cylindrical hole 162 in a portion other than the concave locking portion 164. Therefore, when the convex locking portion 144 is inserted into the cylindrical hole 162, the convex locking portion 144 can be press-fitted into the cylindrical hole 162 by means of the bend of the concave locking portion 164 and the elastic deformation of the eraser 160; when the tip of the convex locking portion 144 reaches the concave locking portion 164, the large diameter portion of the convex locking portion 144 is widened in a radial direction and locked to the concave locking portion 164 to be fitted. In this state, even if the twist-up base 140 or the convex locking portion 144 is to be pulled out toward the end, the large diameter portion of the convex locking portion 144 is locked to the recess of the concave locking portion 164 and cannot be pulled out easily. This can stably fix the eraser 160 to the twist-up base 140. Since the eraser 160 is harder than solid glues, lipsticks, lip balms, or other stick-shaped items, the convex locking portion 144 is firmly locked to the concave locking portion 164. Accordingly, when the eraser is used with normal strength, the concave locking portion 164 is unlikely to lose its shape and separate from the convex locking portion 144.

When the eraser 160 housed in the eraser case 100 is used, i.e., when letters written with a pencil or the like are erased using the eraser 160, the user applies to the eraser 160, relatively strong force required to erase the letters by means of friction on the eraser 160. Therefore, the eraser 160 needs to be firmly fixed to the twist-up base 140 so as not to easily come off from the twist-up base 140. In this regard, since the convex locking portion 144 of the twist-up base 140 is shaped to fit the concave locking portion 164 of the eraser 160 and hence the convex locking portion 144 is locked to the concave locking portion 164, even if the user applies relatively strong force to the eraser 160, the eraser 160 will not easily come off from the twist-up base 140.

The twist-up base 140 and the eraser 160 fixed to the twist-up base 140 are housed in the housing part 122 formed inside the cylindrical container 120, with the twist-up base 140 threadedly engaged with the screw shaft part 132, as shown in the lower part of FIG. 6. The outer diameter of the eraser 160 is slightly smaller than the inner diameter of the housing part 122 such that the eraser 160 is movable in the axial directions within the housing part 122 with a slight gap left around the eraser 160. The hole diameter of the cylindrical hole 162 of the eraser 160 is sufficiently larger than the shaft diameter of the screw shaft part 132.

As shown in the upper part of FIG. 6, the outer diameter of the base body 142 of the twist-up base 140 is slightly smaller than the inner diameter of the cylindrical container 120 such that the twist-up base 140 is slidable in the axial directions inside the cylindrical container 120. However, the tip bulges 149 of the elastic mechanisms 147 extend out of the contour line of the base body 142 and also out of an extension line 180 from the inner wall surface of the cylindrical container 120, which is shown in the lower part and will be described later. As illustrated in a magnified view 181 in which a tip bulge 149 is magnified, each tip bulge 149 extends out of an extension line 180 from the inner wall surface of the cylindrical container 120 by a bulge D1. The bulge D1 may be 0.5 mm, for example.

As shown in the lower part of FIG. 6, when the twist-up base 140 is stored in the cylindrical container 120, the tip bulges 149 of the elastic mechanisms 147 are in contact with the inner wall surface of the cylindrical container 120, and the L-shaped protruding pieces 148 are pressed in an inward direction ID by the amount of the bulge D1 to be bent. In this state, the tip bulges 149 are pressed against the inner wall surface of the cylindrical container 120 by the rebound resilience of the L-shaped protruding pieces 148. In the illustrated state, the whole screw groove 145 in the base hole 146 is positioned in the first idling section 171 of the screw shaft part 132 and is not threadedly engaged with any part of the screw thread 134, so that, even if the rotary operating body 150 is rotated clockwise, the screw shaft part 132 will merely idle. In this state, the tip bulges 149 are pressed against the inner wall surface of the cylindrical container 120, which prevents generation of unnecessary noise due to play of the twist-up base 140 inside the cylindrical container 120 even when the screw thread 134 and the screw groove 145 are not threadedly engaged.

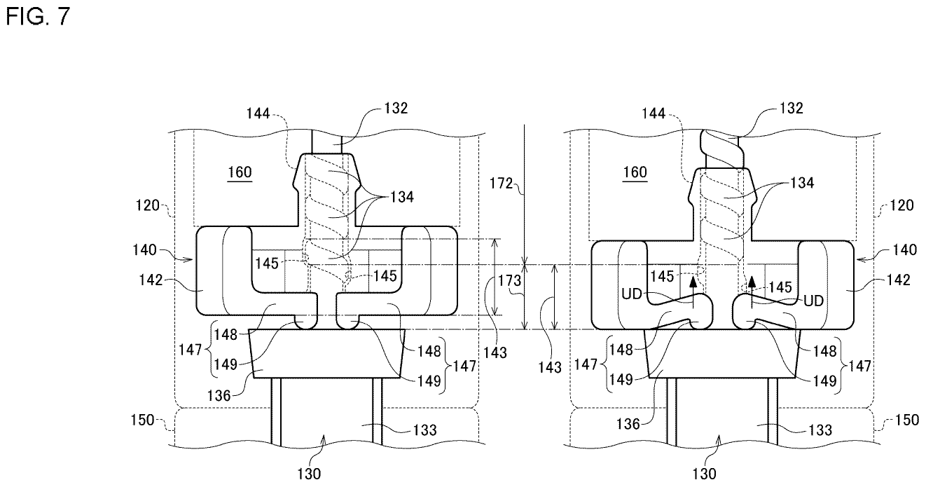

FIG. 7 shows a positional relationship when the twist-up base 140 is positioned on the end side of the screw shaft part 132. In FIG. 7, to clarify the positional relationship between the twist-up base 140 and the screw shaft part 132, the eraser 160, the cylindrical container 120, and the rotary operating body 150 are simplified and indicated by dotted lines, for the sake of convenience.

The left side of FIG. 7 illustrates a state in which, after the rotary operating body 150 is rotated counterclockwise to store the eraser 160 and the twist-up base 140 in the cylindrical container 120, the tip bulges 149 of the elastic mechanisms 147 are in contact with the discoid part 136 of the screw shaft body 130. In this state, the screw thread 134 in an end part of the second thread section 172 is threadedly engaged with the screw groove 145 in an end part of an internal threaded section 143, and, when the rotary operating body 150 is further rotated counterclockwise from this point, the state shown on the right side of FIG. 7 is obtained.

On the right side of FIG. 7, since the L-shaped protruding pieces 148 are bent and deformed, the base body 142 is further lowered to a position that may be in contact with the upper surface of the discoid part 136. The length of the second idling section 173 is equal to or greater than the length of the internal threaded section 143. The screw thread 134 in an end part of the second thread section 172 is released from the screw groove 145 in a tip part of the internal threaded section 143, which then overlaps the second idling section 173; accordingly, even if the rotary operating body 150 is further rotated counterclockwise, the screw shaft body 130 will merely idle. Since the screw shaft body 130 idles, the twist-up base 140 will not be excessively pressed against the discoid part 136, thereby preventing damage to the twist-up base 140.

The tip bulges 149 are in contact with the upper surface of the discoid part 136 in the state shown in the left side of FIG. 7; when the twist-up base 140 is further moved downward as shown in the right side of FIG. 7, the L-shaped protruding pieces 148 are bent in an upward direction UD. With the contact points between the tip bulges 149 and the discoid part 136 as fulcrums, the rebound resilience of the L-shaped protruding pieces 148 causes upward biasing force on the base body 142. When the rotary operating body 150 is rotated clockwise, the base body 142 starts to move upward using the upward biasing force caused by the rebound resilience of the L-shaped protruding pieces 148. Accordingly, the screw thread 134 is threadedly engaged with the screw groove 145 as shown on the left side of FIG. 7, so that the twist-up base 140 can be moved toward the tip opening again.

Although the present embodiment describes an example in which the tip bulges 149 of the elastic mechanisms 147 are in contact with the discoid part 136, in a modification, the tip bulges 149 may be in contact with the bottom part 124 of the cylindrical container 120. Also in this case, on the base body 142, upward biasing force is caused by the rebound resilience of the L-shaped protruding pieces 148, with the contact points between the tip bulges 149 and the bottom part 124 as fulcrums. Therefore, when the rotary operating body 150 is rotated clockwise, the base body 142 moves upward and the screw thread 134 is threadedly engaged with the screw groove 145, so that the twist-up base 140 can be moved toward the tip opening.

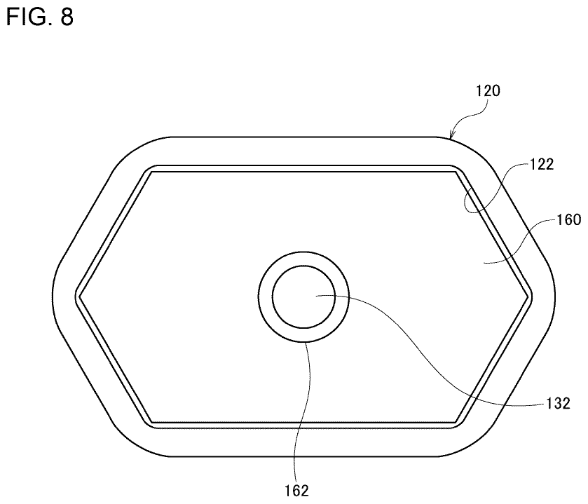

FIG. 8 shows a relationship in terms of shape between the cylindrical container 120 and the eraser 160 viewed from the tip side of the eraser case 100. The cylindrical container 120 is formed in a hexagonal cylinder shape of which the housing part 122 has an axial cross-sectional shape of a flat hexagon. The eraser 160 is also formed in a hexagonal prism shape of which an axial cross-sectional shape is a flat hexagon. The outer diameter of the eraser 160 is slightly smaller than the inner diameter of the housing part 122 of the cylindrical container 120, and the eraser 160 can be stored in the cylindrical container 120 to be extendable and retractable through the tip opening, with a slight gap left around the eraser 160. Each of the inner wall surface of the housing part 122 of the cylindrical container 120 and the outer circumferential surface of the eraser 160 is formed such that an axial cross section thereof has a shape other than a perfect circle, such as a hexagon. This prevents the eraser 160 from rotating inside the cylindrical container 120 along with the rotation of the rotary operating body 150. Also, when letters are erased with the eraser 160, the eraser can be prevented from rotating against the twist-up base 140 while force is applied. Furthermore, with the increased number of corner portions, which are advantageous for erasing letters and the like, the convenience can be enhanced.

Also, an axial cross-sectional shape of the rotary operating body 150, not illustrated, is a flat hexagon, which almost coincides with an axial cross-sectional shape of the cylindrical container 120. The case where the cross-sectional shapes of the cylindrical container 120 and the rotary operating body 150 are flat hexagons differ from the case where those are regular hexagons in that the position of a half revolution can be easily understood from the position of the rotary operating body 150 relative to the cylindrical container 120 after the rotary operating body 150 is rotated, and counting the number of revolutions is also facilitated. Also, unlike the case of regular hexagonal cross-sectional shapes, each user is less likely to hold it as if holding a pencil and more likely to grasp it naturally with his or her palm, which facilitates applying force when erasing letters and the like.

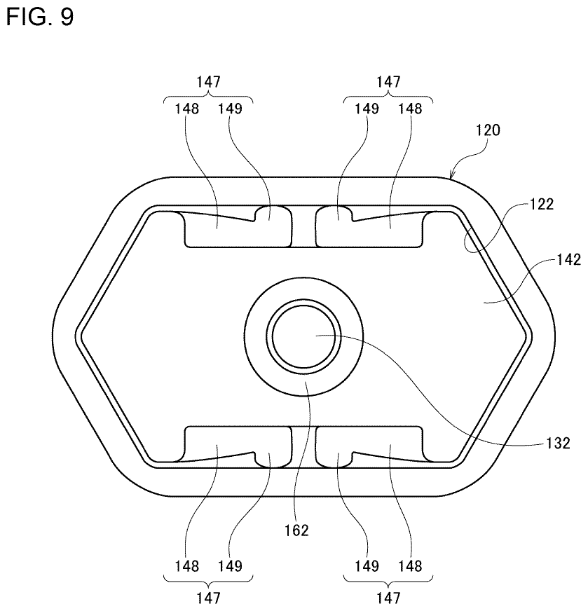

FIG. 9 shows a relationship in terms of shape between the cylindrical container 120 and the twist-up base 140 viewed from the tip side of the eraser case 100. As with the cylindrical container 120, the base body 142 of the twist-up base 140 is also formed in a hexagonal prism shape of which an axial cross-sectional shape is almost a rounded flat hexagon. The outer diameter of the base body 142 is slightly smaller than the inner diameter of the housing part 122 of the cylindrical container 120, and the twist-up base 140 is slidable in the axial directions inside the housing part 122. Each of the inner wall surface of the housing part 122 of the cylindrical container 120 and the outer circumferential surface of the base body 142 is formed such that an axial cross section thereof has a shape other than a perfect circle, such as a flat hexagon. This prevents the twist-up base 140 from rotating inside the cylindrical container 120 along with the rotation of the rotary operating body 150 and also from not moving in the axial directions. Although the cross-sectional shape of the base body 142 is strictly a shape like a double-headed arrow, the overall shape including the elastic mechanisms 147 is almost a flat hexagon. However, each tip bulge 149 has a shape that extends out of the contour line of the base body 142 toward the inner wall surface of the housing part 122 and is in contact with the inner wall surface of the housing part 122, and each L-shaped protruding piece 148 is deformed and bent while being stored in the housing part 122.

### Second Embodiment

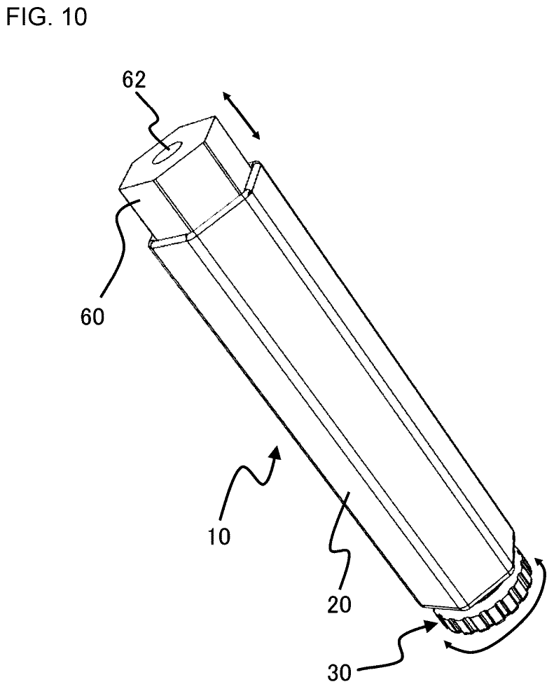

FIG. 10 illustrates an appearance of an eraser case according to the second embodiment. An eraser case 10 mainly includes a cylindrical container 20 and a screw shaft body 30. The cylindrical container 20 is a bottomed cylindrical resin member without a lid and has an axial cross-sectional shape of a rounded hexagon. An eraser 60 has a hexagonal prism shape of which an axial cross-sectional shape is a rounded hexagon in which a cylindrical hole 62 is formed through the central axis. The outer diameter of the eraser 60 is slightly smaller than the inner diameter of the cylindrical container 20, and the eraser 60 can be stored in the cylindrical container 20 with a slight gap left around the eraser 60. The screw shaft body 30 is a resin member including a screw shaft part, not illustrated in FIG. 10. The screw shaft part is inserted into the cylindrical hole 62 of the eraser 60 stored in the cylindrical container 20 and also into a hole provided in a bottom part of the cylindrical container 20. By rotating the screw shaft body 30 in a predetermined direction, the eraser 60 is extended from the cylindrical container 20 and, by rotating the screw shaft body 30 in the opposite direction, the eraser 60 is retracted into the cylindrical container 20.

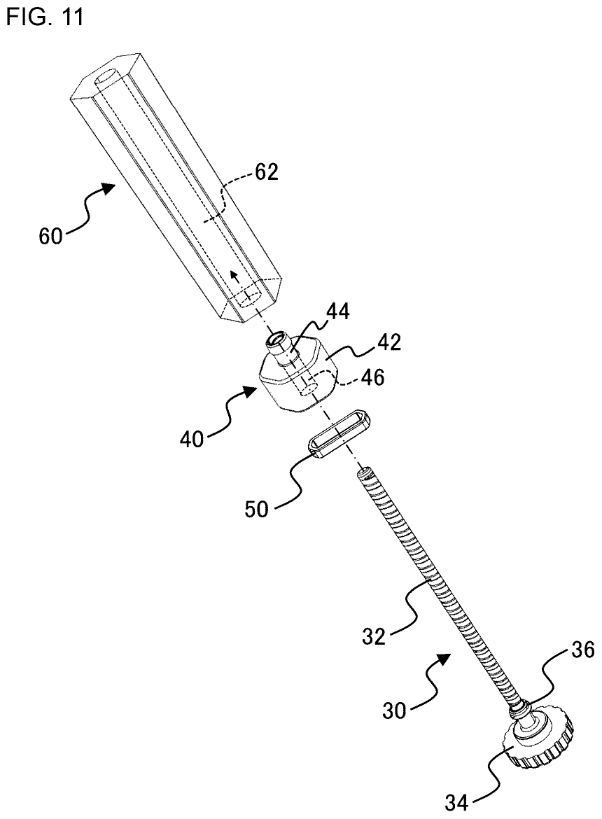

FIG. 11 illustrates an internal configuration of the eraser case 10 without the cylindrical container 20. The cylindrical hole 62 in the eraser 60 is a cylindrical hole formed through the central axis. The opening on the tip side of the cylindrical hole 62 in the eraser 60 does not have any particular function or role. Accordingly, as a modification, the cylindrical hole 62 may be structured to extend to near the tip of the eraser 60 but not completely pierce through to the tip, i.e., to have an opening only on the end side. However, by configuring the cylindrical hole 62 to pierce through to the tip side, the eraser 60 can be manufactured by extrusion or injection molding with a constant cross-sectional shape from the tip to the end, thereby simplifying the manufacturing process.

A twist-up base 40 is a resin member that includes a base body 42 having a hexagonal prism shape of which a cross-sectional shape is a rounded hexagon, and a convex locking portion 44 protruding upward from the center of the upper surface of the base body 42. The convex locking portion 44 has at the tip, a shape of an annular snap fit joint folded back like an umbrella, i.e., a click folded back in a tapered sloping shape is provided around the tip of a projection, and the folded end portion is formed at about 90 degrees. When the convex locking portion 44 is press-fitted into the cylindrical hole 62 of the eraser 60, the folded end portion is locked and fixed to a concave locking portion, which will be detailed later, provided near the end of the cylindrical hole 62. At the center of the base body 42, a cylindrical base hole 46 is formed through the base body 42 and the convex locking portion 44. The base hole 46 is a screw hole with a thread groove spirally formed on its inner wall. The outer diameter of the base body 42 is slightly smaller than the inner diameter of the cylindrical container 20, and the base body 42 is slidable in the axial directions inside the cylindrical container 20.

A stop element 50 is an annular member for preventing the screw shaft body 30 inserted into the cylindrical container 20 from coming off from the cylindrical container 20. The stop element 50 may be formed of a flexible resin, for example. The screw shaft body 30 is inserted through the hollow portion of the stop element 50 such that the stop element 50 is located near the end of the screw shaft body 30. An axial cross-sectional shape of the stop element 50 is a long hexagon with rounded corners in which some parallel sides are longer than other sides. The stop element 50 will be detailed later. Although the stop element 50 in the example of FIG. 11 is formed in an annular shape, in a modification, the stop element 50 may be formed in a shape partially provided with a cutout, such as a U-shape.

A screw shaft body 30 includes a screw shaft part 32, which is a rod-shaped member with a spiral screw thread formed on the outer circumference, and a rotary operating part 34, which is a part corresponding to a screw head formed at the end of the screw shaft part 32. The shaft diameter of the screw shaft part 32 is smaller than the hole diameter of the cylindrical hole 62 such that, when the screw shaft part 32 is inserted into the cylindrical hole 62 of the eraser 60, the outer circumference of the screw shaft part 32 does not come into contact with the inner wall surface of the cylindrical hole 62. Also, the shaft diameter of the screw shaft part 32 is smaller than the hole diameter of the base hole 46 of the twist-up base such that the screw shaft part 32 is threadedly engaged with the base hole 46. The rotary operating part 34 has a discoid shape of which the outer diameter is sufficiently larger than the shaft diameter of the screw shaft part 32, and the size of the rotary operating part 34 is such that it is inscribed in the outer shape of the cylindrical container 20 in a cross-sectional shape. On the outer circumference of the rotary operating part 34, anti-slip vertical grooves are formed. A user holds the circumference of the rotary operating part 34 and rotates it to extend or retract the eraser 60.

At a predetermined position near the end of the screw shaft body 30, a protrusion 36 is provided such that the screw shaft part 32 partially extends in a radial direction thereof. The protrusion 36 is provided to press-fit the stop element 50 around the end of the screw shaft part 32 and to fasten the stop element 50 to the end portion of the screw shaft part 32. The distance between parallel long sides in an axial cross-sectional shape of the stop element 50 is slightly longer than the diameter of the screw shaft part 32 but shorter than the diameter at the portion of the protrusion 36. Since the stop element 50 is flexible, the distance between parallel long pieces can vary somewhat when pressure is applied. Accordingly, when the screw shaft part 32 is inserted through the hollow portion of the annular stop element 50 such that the stop element 50 is located near the end of the screw shaft part 32, by further press-fitting the stop element 50 that has come into contact with the protrusion 36, the stop element 50 bends to open the space in the hollow portion thereof and passes over the protrusion 36. As a result, the stop element 50 is disposed between the protrusion 36 and the rotary operating part 34. The protrusion 36 has a shape of an annular snap fit joint such that the tip side in an axial direction thereof is inclined and the end side in an axial direction thereof provides locking, so that the stop element 50 is less likely to come off to the tip side in an axial direction.

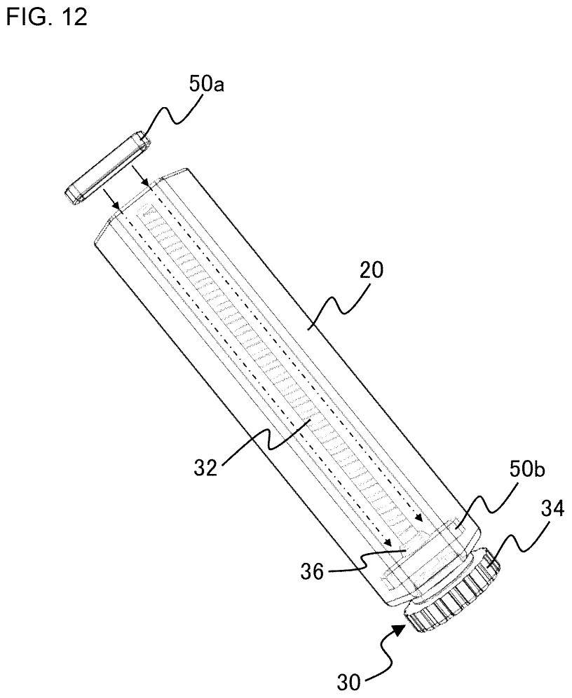

FIG. 12 illustrates a process of attaching the screw shaft body 30 and the stop element 50 to the cylindrical container 20. The cylindrical container 20 in FIG. 12 is illustrated such that the interior can be seen through, for the sake of convenience. With the screw shaft part 32 of the screw shaft body 30 inserted into a hole provided in a bottom part of the cylindrical container 20 from below, the stop element 50 (a stop element 50a in FIG. 12) is inserted through an opening at the tip of the cylindrical container 20 such that the screw shaft part 32 passes through the hollow portion of the stop element 50. The stop element 50 is then moved to near the end of the screw shaft part 32 to come into contact with the protrusion 36, and the stop element 50 is pushed to pass over the protrusion 36 and reach the position of a stop element 50b. Even if a force in the direction of pulling the screw shaft body 30 out of the cylindrical container 20 is applied, the protrusion 36 will be locked by the stop element 50, preventing unintended coming off of the screw shaft body 30. The stop element 50 is shaped such that at least part of the side surface thereof, such as multiple vertices in an axial cross-sectional shape of the stop element 50, can be lightly in contact with the inner circumferential surface of the cylindrical container 20. Also, since the vertical width of the stop element 50 is slightly smaller than the distance along the screw shaft part 32 from the lower end of the protrusion 36 to the bottom part, the stop element 50 is disposed such as to be sandwiched between the protrusion 36 and the bottom part of the cylindrical container 20. Accordingly, excessive play is not provided at the position of the stop element and unnecessary noise is less likely to occur.

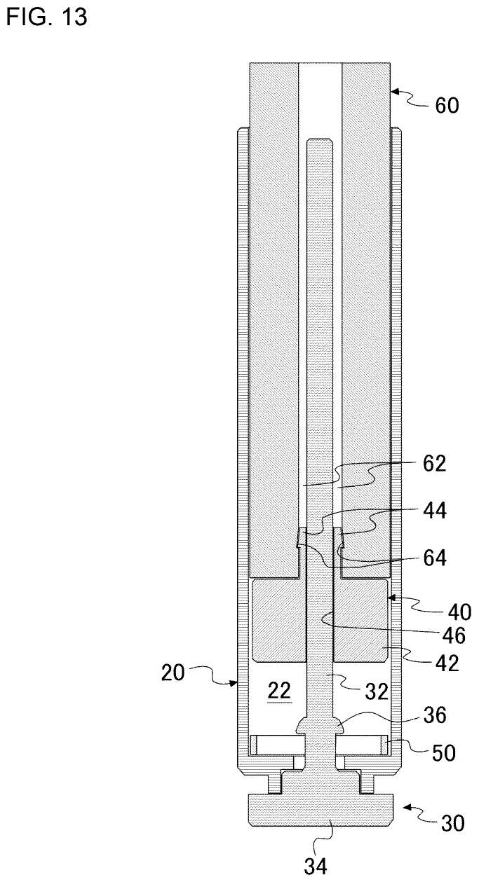

FIG. 13 is a sectional view that shows an internal structure of the eraser case 10. The shape of the twist-up base 40 will be described first. The outer diameter of the base body 42 of the twist-up base 40 is slightly smaller than the inner diameter of the cylindrical container 20 such that the twist-up base 40 is slidable in the axial directions inside the cylindrical container 20. The convex locking portion 44 of the twist-up base 40 has a shape of an annular snap fit joint protruding cylindrically upward from the base body 42. The outer diameter of the convex locking portion 44 at its base or end (near the contact point with the base body 42) is slightly smaller than the hole diameter of the cylindrical hole 62 of the eraser 60. Also, the convex locking portion 44 has an umbrella-like folded shape in which the outer diameter near the center in an axial direction of the convex locking portion 44 extends in a radial direction such as to bulge substantially vertically from the outer diameter at the base or end and tapers conically therefrom toward the tip. The base hole 46, piercing through the center of the base body 42 and the convex locking portion 44, is a screw hole with a screw groove spirally formed on its inner wall, and the hole diameter thereof is slightly larger than the outer diameter of the screw shaft part 32 and is of sufficient size to allow the screw shaft part 32 to be threadedly engaged with the base hole 46.

On the inner wall surface of the cylindrical hole 62 of the eraser 60, near the end, a concave locking portion 64 is formed in a shape that the convex locking portion 44 can fit into. More specifically, the cylindrical hole 62 has a shape in which the end side of the concave locking portion 64 is slightly recessed substantially vertically or in a radial direction such that the hole diameter of the cylindrical hole 62 becomes maximum at the position of the concave locking portion 64 and inclined therefrom such that the hole diameter of the cylindrical hole 62 becomes smaller toward the tip side. The hole diameter of the cylindrical hole 62, excluding a portion corresponding to the convex locking portion 44, is slightly larger than the outer diameter of the base or end of the convex locking portion 44. Also, the largest outer diameter of the convex locking portion 44 is larger than the hole diameter of the cylindrical hole 62 in a portion other than the concave locking portion 64. Therefore, when the convex locking portion 44 is inserted into the cylindrical hole 62, the convex locking portion 44 can be press-fitted into the cylindrical hole 62 by means of the bend of the concave locking portion 64 and the elastic deformation of the eraser 60; when the tip of the convex locking portion 44 reaches the concave locking portion 64, the large diameter portion of the convex locking portion 44 is widened in a radial direction and locked to the concave locking portion 64 to be fitted. In this state, even if the twist-up base 40 or the convex locking portion 44 is to be pulled out toward the end, the large diameter portion of the convex locking portion 44 is locked to the recess of the concave locking portion 64 and cannot be pulled out easily. This can stably fix the eraser 60 to the twist-up base 40. Since the eraser 60 is harder than solid glues, lipsticks, lip balms, or other stick-shaped items, the convex locking portion 44 is firmly locked to the concave locking portion 64. Accordingly, when the eraser is used with normal strength, the concave locking portion 64 is unlikely to lose its shape and separate from the convex locking portion 44.

The twist-up base 40 and the eraser 60 fixed to the twist-up base 40 are housed in the housing part 22 formed inside the cylindrical container 20, with the twist-up base 40 threadedly engaged with the screw shaft part 32 of the screw shaft body 30, which is inserted through the hole in the bottom part of the cylindrical container 20 and passed through the stop element 50, as shown in FIG. 12. The outer diameter of the eraser 60 is slightly smaller than the inner diameter of the housing part 22 such that the eraser 60 is movable in the axial directions within the housing part 22 with a slight gap left around the eraser 60. The hole diameter of the cylindrical hole 62 of the eraser 60 is sufficiently larger than the shaft diameter of the screw shaft part 32. The maximum outer diameter of the stop element 50 is smaller than the inner diameter of the housing part 22. The stop element 50 is disposed such as to be sandwiched between the lower end of the protrusion 36 and the bottom part of the housing part 22. When a user rotates the rotary operating part 34 of the screw shaft body 30, the axial rotational motion of the screw shaft body 30 is converted into an axial motion, i.e., a linear motion, of the twist-up base 40 by the threaded engagement of the screw shaft part 32 and the twist-up base 40. For example, when the rotary operating part 34 is rotated counterclockwise, the eraser 60 and the twist-up base 40 are retracted toward the bottom part of the housing part 22 and stored, and, when the rotary operating part 34 is rotated clockwise, the eraser 60 and the twist-up base 40 are extended and moved in the direction toward the opening of the housing part 22. The more the eraser 60 and the twist-up base 40 are extended and moved, the more the tip of the eraser 60 is pushed out and exposed outside the cylindrical container 20. One rotation of the rotary operating part 34 moves the eraser 60 up and down by about 3.0 mm, and the amount of the eraser 60 exposed to the outside can be freely adjusted by the amount of rotation of the rotary operating part 34. When the eraser 60 becomes worn and short as it is used, by rotating the rotary operating part 34 clockwise by the shortened amount, the tip of the eraser 60 can be exposed outside the cylindrical container 20.

When the eraser 60 housed in the eraser case 10 is used, i.e., when letters written with a pencil or the like are erased using the eraser 60, the user applies to the eraser 60, relatively strong force required to erase the letters by means of friction on the eraser 60. Therefore, the eraser 60 needs to be firmly fixed to the twist-up base 40 so as not to easily come off from the twist-up base 40. In this regard, since the convex locking portion 44 of the twist-up base 40 is shaped to fit the concave locking portion 64 of the eraser 60 and hence the convex locking portion 44 is locked to the concave locking portion 64, even if the user applies relatively strong force to the eraser 60, the eraser 60 will not easily come off from the twist-up base 40.

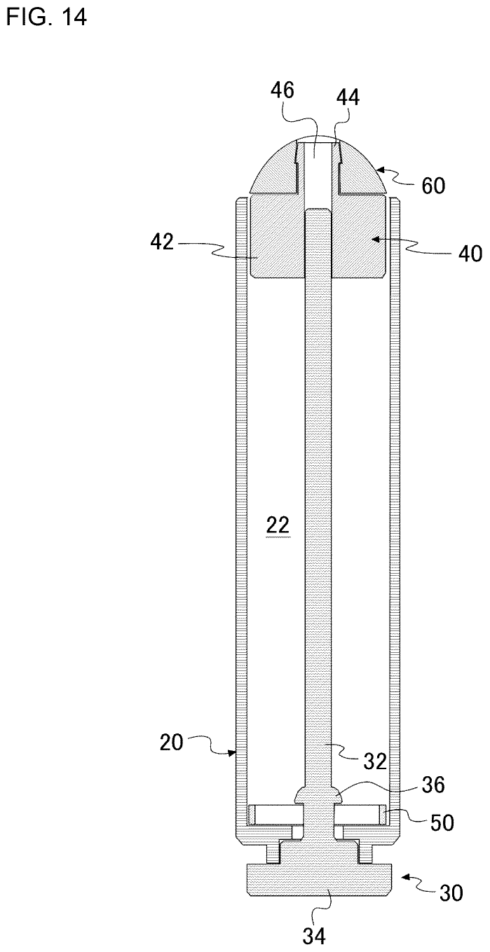

FIG. 14 is a sectional view that shows a state of the eraser worn down to the maximum. When the eraser 60 has been used and worn down to the maximum extent, the eraser 60 is left in a shape like a “mountain,” with the vicinity of the opening of the convex locking portion 44 as the top and inclined therefrom to the vicinity of the upper surface of the twist-up base 40, as shown in FIG. 14. In order to use the eraser 60 to reach such a state, i.e., up to near the contact point between the eraser 60 and the twist-up base 40, it is necessary to expose the entire eraser 60, including the end portion, to the outside of the cylindrical container 20. In this regard, since the screw shaft part 32 of the screw shaft body 30 is long enough so that the tip thereof reaches the vicinity of the opening of the housing part 22, the twist-up base 40 can be moved upward to a position where the upper surface of the twist-up base 40 can be exposed outside the cylindrical container 20. Also, since the eraser 60 is fixed such as to be placed on the upper surface of the twist-up base 40 so that the entire eraser 60 is exposed, by moving the twist-up base 40 to the vicinity of the opening of the cylindrical container 20, the entire eraser 60, including the end thereof, can be exposed outside the cylindrical container 20. Accordingly, the end of the eraser 60 is not hidden by the cylindrical container 20 or the twist-up base 40, and the eraser 60 can be used up to the very end, enabling the use of the eraser 60 without waste. Meanwhile, it is difficult to use such an eraser worn down to be extremely small because the size thereof is too precarious to pick up with fingers for use. However, with the eraser case 10 according to the present embodiment, even an eraser that has become extremely small can be easily picked up with a hand or fingers and used, so that, also in this regard, an eraser can be used easily to the end without waste.

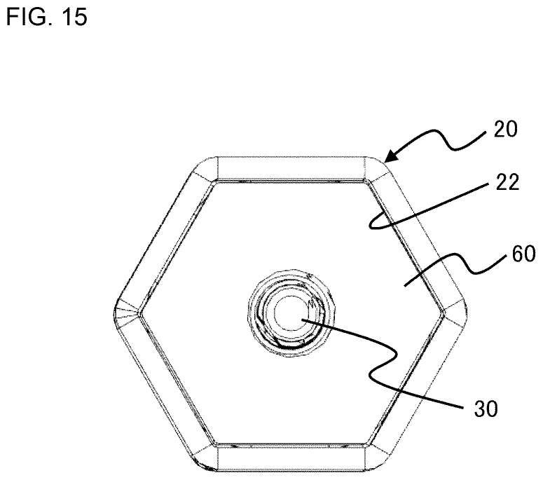

FIG. 15 shows a relationship in terms of shape between the cylindrical container 20 and the eraser 60 viewed from the tip side of the eraser case 10. The cylindrical container 20 is formed in a hexagonal cylinder shape of which the housing part 22 has an axial cross-sectional shape of a hexagon. The eraser 60 is also formed in a hexagonal prism shape of which an axial cross-sectional shape is a hexagon. The outer diameter of the eraser 60 is slightly smaller than the inner diameter of the housing part 22 of the cylindrical container 20, and the eraser 60 can be stored in the cylindrical container 20 to be extendable and retractable through the tip opening, with a slight gap left around the eraser 60. Each of the inner wall surface of the housing part 22 of the cylindrical container 20 and the outer circumferential surface of the eraser 60 is formed such that an axial cross section thereof has a shape other than a perfect circle, such as a hexagon. This prevents the eraser 60 from rotating inside the cylindrical container 20 along with the rotation of the rotary operating part 34. Further, when letters are erased with the eraser 60, the eraser can be prevented from rotating against the twist-up base 40 while force is applied.

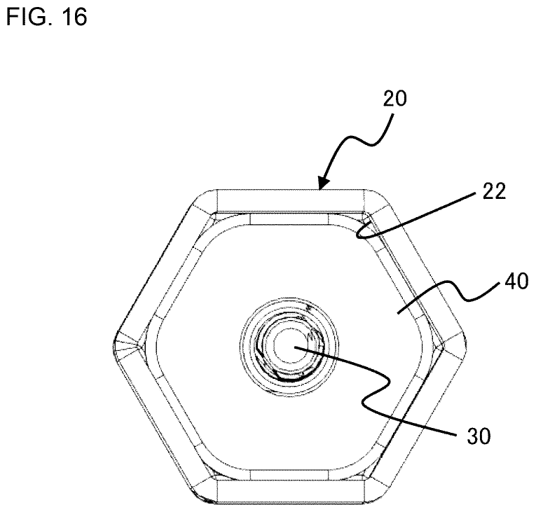

FIG. 16 shows a relationship in terms of shape between the cylindrical container 20 and the twist-up base 40 viewed from the tip side of the eraser case 10. As with the cylindrical container 20, the base body 42 of the twist-up base 40 is also formed in a hexagonal prism shape of which an axial cross-sectional shape is a rounded hexagon. The outer diameter of the base body 42 is slightly smaller than the inner diameter of the housing part 22 of the cylindrical container 20, and the twist-up base 40 is slidable in the axial directions inside the housing part 22. Each of the inner wall surface of the housing part 22 of the cylindrical container 20 and the outer circumferential surface of the base body 42 is formed such that an axial cross section thereof has a shape other than a perfect circle, such as a hexagon. This prevents the twist-up base 40 from rotating inside the cylindrical container 20 along with the rotation of the rotary operating part 34 and also from not moving in the axial directions.

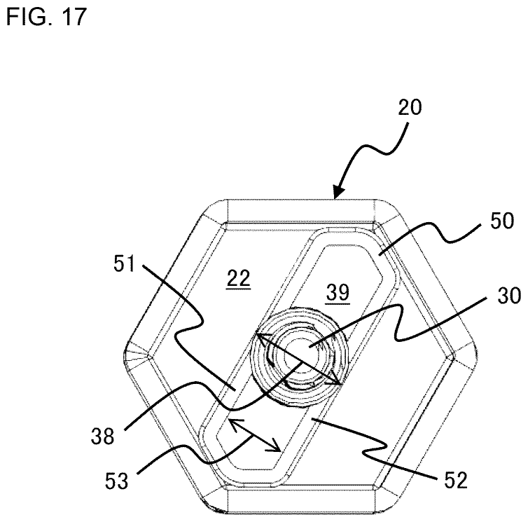

FIG. 17 shows a relationship in terms of shape between the cylindrical container 20 and the stop element 50 viewed from the tip side of the eraser case 10. An axial cross-sectional shape of the stop element 50 is a long hexagon with rounded corners, formed annularly such that a first side 51 and a second side 52 parallel with each other are longer than other sides. The inside of the annular portion of the stop element 50 forms a long hexagonal hollow portion 39, and a space 53 between the first side 51 and the second side 52 is slightly smaller than a protrusion diameter 38, which is the maximum diameter of the protrusion 36 of the screw shaft body 30. Accordingly, when the screw shaft part 32 of the screw shaft body 30 is inserted through the hollow portion 39 of the stop element 50, by further press-fitting the stop element 50 that has come into contact with the protrusion 36, the stop element 50 bends to open the space 53 in the hollow portion 39 to a size similar to the protrusion diameter 38 and passes over the protrusion 36. As a result, the stop element 50 is disposed between the protrusion 36 and the bottom part of the housing part 22.

### Third Embodiment

In an eraser case according to the third embodiment, each of the eraser, cylindrical container, and twist-up base is formed in a rectangular parallelepiped shape, which differs from the eraser case of the second embodiment in which each of them is formed in a hexagonal prism shape; the other features are the same as those of the eraser case in the second embodiment. In the following, description will be given mainly for the differences from the second embodiment, and the explanation of features in common will be omitted. Also, the reference character for each configuration in the third embodiment is the same as that for the corresponding configuration in the second embodiment.

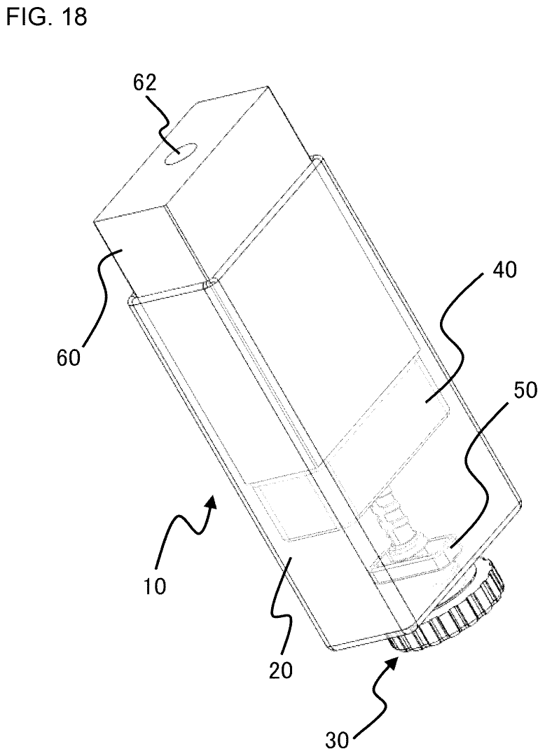

FIG. 18 illustrates an appearance of the eraser case according to the third embodiment. The eraser case 10 includes the cylindrical container 20, screw shaft body 30, twist-up base 40, and stop element 50, and, in the cylindrical container 20, the eraser 60 is stored to be extendable and retractable. In FIG. 18, the cylindrical container 20 is illustrated such that the interior can be seen through, for the sake of convenience.

The cylindrical container 20 is a bottomed cylindrical member without a lid and has an axial cross-sectional shape of a rounded rectangle. The eraser 60 also has an axial cross-sectional shape of a rounded rectangle, and the cylindrical hole 62 is formed through the central axis. The eraser 60 has size that can be housed in a housing part of the cylindrical container 20, and the eraser 60 fixed to the twist-up base 40 can be stored in the cylindrical container 20, with a slight gap left around the eraser 60. The twist-up base 40 also has size that can be housed in the housing part of the cylindrical container 20, and the twist-up base 40 is stored to be slidable on the inner wall surface of the cylindrical container 20. The shapes and structures of the screw shaft body 30 and the stop element 50 are the same as those in the second embodiment.

Also in the present embodiment, an axial cross section of each of the inner wall of the cylindrical container 20, the outer circumference of the eraser 60, and the outer circumference of the twist-up base 40 has a shape other than a perfect circle. This prevents the twist-up base 40 from rotating inside the cylindrical container 20 along with the rotation of the rotary operating part 34 and also from not moving in the axial directions.

As described above, an eraser case according to the second or third embodiment includes: a cylindrical container in which an eraser with a cylindrical hole is stored to be extendable and retractable through an opening at the tip; a twist-up base that is slidable in an axial direction inside the cylindrical container and to which an end part of an eraser stored in the cylindrical container is fixed; and a screw shaft body that can be inserted into the cylindrical hole of the eraser and that can push the twist-up base out by being inserted into and threadedly engaged with a screw hole piercing through the twist-up base to convert an axial rotational motion into an axial motion of the twist-up base. The twist-up base includes a convex locking portion protruding toward the eraser, and the convex locking portion fixes the eraser to the twist-up base by being locked to a concave locking portion provided on an inner wall surface of the cylindrical hole of the eraser.

The convex locking portion of the twist-up base may have a shape of a snap fit joint protruding upward from the upper surface of the base body. The concave locking portion may have a concave shape into which the convex shape of the convex locking portion fits. According to this aspect, with the convex locking portion locked to the concave locking portion, the eraser can be fixed such as to be placed on the upper surface of the base body of the twist-up base. In this case, the end part of the eraser can be exposed without being hidden by the twist-up base, making it easier to use the eraser to near the end and reducing waste.

Each of an inner wall surface of the cylindrical container and an outer circumferential surface of the twist-up base may have an axial cross-sectional shape other than a perfect circle, such as a polygon with multiple vertices, including a hexagon, rectangle, and square, or an ellipse. According to this aspect, when the screw shaft body is rotated, the eraser is prevented from performing an axial rotational motion along with the screw shaft body inside the cylindrical container to interfere with the axial motion of the eraser.

The eraser case may further include a stop element for preventing the screw shaft body inserted into the cylindrical container from coming off from the cylindrical container. The cylindrical container may have a bottomed shape without a lid and may include, in its bottom part, a hole into which the screw shaft body is inserted. The screw shaft body may include a screw shaft part provided with a spiral groove on its outer circumference, and, at a certain position on the outer circumference of the screw shaft part, a protrusion may be provided. The stop element may have a hollow portion with a width into which the screw shaft body and the protrusion can be press-fitted, and the stop element may be disposed such as to be sandwiched between the protrusion of the screw shaft body, which is inserted through the hollow portion and the hole of the cylindrical container, and the bottom part of the cylindrical container. When a force in the direction of pulling the screw shaft body out of the cylindrical container is applied, the protrusion may be locked by the stop element. According to this aspect, even if a force in the direction of pulling the screw shaft body out of the cylindrical container is applied, the protrusion will be locked by the stop element, preventing unintended coming off of the screw shaft body.

The stop element may be shaped such that multiple vertices in an axial cross-sectional shape of the stop element can be in contact with the inner circumferential surface of the cylindrical container. According to this aspect, excessive play is not provided at the stop element between the bottom part of the cylindrical container and the protrusion of the screw shaft body, and unnecessary noise is less likely to occur.

The eraser case 100 and the eraser case 10 according to embodiments of the present invention have been described above. The embodiments are intended to be illustrative only, and it will be obvious to those skilled in the art that various modifications to a combination of the constituting elements could be developed and that such modifications also fall within the scope of the present invention.

What is claimed is:

1. An eraser case comprising:
a cylindrical container in which an eraser with a cylindrical hole is stored to be extendable and retractable through an opening at the tip;
a twist-up base that is slidable in an axial direction inside the cylindrical container and to which an end part of an eraser stored in the cylindrical container is fixed; and
a screw shaft body that can be inserted into the cylindrical hole of the eraser and that can push the twist-up base out by being inserted into and threadedly engaged with a screw hole piercing through the twist-up base to convert an axial rotational motion into an axial motion of the twist-up base, wherein
the twist-up base comprises a convex locking portion protruding toward the eraser, and the convex locking portion fixes the eraser to the twist-up base by being locked to a concave locking portion provided on an inner wall surface of the cylindrical hole of the eraser.

2. The eraser case according to claim 1, wherein each of an inner wall surface of the cylindrical container and an outer circumferential surface of the twist-up base has an axial cross-sectional shape other than a perfect circle.

3. The eraser case according to claim 1, wherein the convex locking portion has a shape of a snap fit joint.

4. The eraser case according to claim 2, wherein the convex locking portion has a shape of a snap fit joint.

5. The eraser case according to claim 1, wherein the screw shaft body comprises a screw shaft part including, on at least part of its outer circumference, a spiral screw thread that can be threadedly engaged with the screw hole in the twist-up base, and, on the outer circumference of the screw shaft part, an idling section that is not threadedly engaged with the screw hole is provided in at least one of the vicinity of the tip or the vicinity of the end in an axial direction, and a thread section that can be threadedly engaged with the screw hole is provided in a portion other than the idling section.

6. The eraser case according to claim 2, wherein the screw shaft body comprises a screw shaft part including, on at least part of its outer circumference, a spiral screw thread that can be threadedly engaged with the screw hole in the twist-up base, and, on the outer circumference of the screw shaft part, an idling section that is not threadedly engaged with the screw hole is provided in at least one of the vicinity of the tip or the vicinity of the end in an axial direction, and a thread section that can be threadedly engaged with the screw hole is provided in a portion other than the idling section.

7. The eraser case according to claim 1, wherein
the cylindrical container has a bottomed shape without a lid, and
the twist-up base can be in contact with another member in an inner bottom of the cylindrical container when the screw shaft body is rotated in the storing direction, and an elastic mechanism is provided in the portion in contact with the another member.

8. The eraser case according to claim 2, wherein
the cylindrical container has a bottomed shape without a lid, and
the twist-up base can be in contact with another member in an inner bottom of the cylindrical container when the screw shaft body is rotated in the storing direction, and an elastic mechanism is provided in the portion in contact with the another member.

9. The eraser case according to claim 1, wherein
the screw shaft body comprises a screw shaft part including, on at least part of its outer circumference, a spiral screw thread that can be threadedly engaged with the screw hole in the twist-up base, and, on the outer circumference of the screw shaft part, an idling section that is not threadedly engaged with the screw hole is provided in the vicinity of the end in an axial direction, and a thread section that can be threadedly engaged with the screw hole is provided in a portion other than the idling section,
the cylindrical container has a bottomed shape without a lid, and
the twist-up base can be in contact with another member in an inner bottom of the cylindrical container when the screw shaft body is rotated in the storing direction, an elastic mechanism is provided in the portion in contact with the another member, and the section of the screw hole in the twist-up base and the idling section can overlap due to deformation of the elastic mechanism.

10. The eraser case according to claim 2, wherein
the screw shaft body comprises a screw shaft part including, on at least part of its outer circumference, a spiral screw thread that can be threadedly engaged with the screw hole in the twist-up base, and, on the outer circumference of the screw shaft part, an idling section that is not threadedly engaged with the screw hole is provided in the vicinity of the end in an axial direction, and a thread section that can be threadedly engaged with the screw hole is provided in a portion other than the idling section,
the cylindrical container has a bottomed shape without a lid, and
the twist-up base can be in contact with another member in an inner bottom of the cylindrical container when the screw shaft body is rotated in the storing direction, an elastic mechanism is provided in the portion in contact with the another member, and the section of the screw hole in the twist-up base and the idling section can overlap due to deformation of the elastic mechanism.

11. The eraser case according to claim 1, wherein
the screw shaft body comprises a screw shaft part including, on at least part of its outer circumference, a spiral screw thread that can be threadedly engaged with the screw hole in the twist-up base, and
the outer circumference of the screw shaft part includes, in an axial direction, a first thread section provided in part of the vicinity of the tip, an idling section that is not threadedly engaged with the screw hole and is provided in the vicinity of the tip other than the first thread section, and a second thread section provided in a portion other than the first thread section and the idling section.

12. The eraser case according to claim 2, wherein
the screw shaft body comprises a screw shaft part including, on at least part of its outer circumference, a spiral screw thread that can be threadedly engaged with the screw hole in the twist-up base, and
the outer circumference of the screw shaft part includes, in an axial direction, a first thread section provided in part of the vicinity of the tip, an idling section that is not threadedly engaged with the screw hole and is provided in the vicinity of the tip other than the first thread section, and a second thread section provided in a portion other than the first thread section and the idling section.

13. The eraser case according to claim 5, wherein an axial length of the idling section is equal to or greater than an axial length of the screw hole in the twist-up base.

14. The eraser case according to claim 6, wherein an axial length of the idling section is equal to or greater than an axial length of the screw hole in the twist-up base.

15. The eraser case according to claim 11, wherein an axial length of the idling section is equal to or greater than an axial length of the screw hole in the twist-up base.

16. The eraser case according to claim 12, wherein an axial length of the idling section is equal to or greater than an axial length of the screw hole in the twist-up base.

17. The eraser case according to claim 1, wherein, in the twist-up base, an elastic mechanism is provided such that part thereof protrudes toward an inner wall surface of the cylindrical container and can be in contact with the inner wall surface.

18. The eraser case according to claim 2, wherein in the twist-up base, an elastic mechanism is provided such that part thereof protrudes toward an inner wall surface of the cylindrical container and can be in contact with the inner wall surface.
